(19) United States
(12) Patent Application Publication
(10) Pub. No.: US 2016/0042415 A1
(43) Pub. Date: Feb. 11, 2016

(54) NETWORK-BASED PROCUREMENT MARKETPLACE SERVICES

(71) Applicant: Eric Byungho Min, Austin, TX (US)

(72) Inventor: Eric Byungho Min, Austin, TX (US)

(21) Appl. No.: 14/452,471

(22) Filed: Aug. 5, 2014

(51) Int. Cl. G06Q 30/06

(52) U.S. Cl. CPC G06Q 30/0611; G06Q 30/0613; G06Q 30/0635

(57) ABSTRACT

A network-based procurement marketplace system and method is provided to facilitate establishment and development of procurement transactions between purchasers and purchasing agents. Purchasers can submit purchase offers, each of which specifies requested merchandise that is to be acquired and delivered to the purchaser. Purchase offers are published, in some instances only to purchasing agents within a particular geographical region associated with the purchaser. The purchasing agent can submit a procurement claim for all or part of the requested merchandise. Before fulfilment of the procurement claim, funds may automatically be secured from a purchaser account for payment to the purchasing agent, to allow prompt an estimated payment to the purchasing agent upon delivery notification with respect to the claimed merchandise.

### TECHNICAL FIELD

Example embodiments of the present application generally relate to data processing techniques. For example, the disclosure describes techniques for providing a network-based procurement marketplace service for facilitating matching of prospective purchasers to purchasing agents for procurement of trade merchandise.

### BACKGROUND

Online shopping services have become commonplace. Online merchants typically provide for delivery services, so that a shopper has the option of having purchased goods delivered to a specified address at a fee. Some brick-and-mortar vendors likewise provide an online shopping interface that can be used by shoppers to purchase goods and arrange for delivery thereof to the shopper's home address.

Some merchandise, however, is not available for online purchase, while some merchandise that can be bought online is not available for subsequent delivery by the vendor or merchant. In such cases, the purchaser can only acquire the merchandise by personally collecting it from a vendor site.

### BRIEF DESCRIPTION OF THE DRAWINGS

Various features of the disclosure are illustrated by way of example, and not by way of limitation, in the figures of the accompanying drawings in which:

FIG. 1 is a block diagram depicting an example operating environment for providing a network-based procurement marketplace service, in accordance with an example embodiment.

FIG. 2 is a flowchart depicting a method for providing a network-based procurement marketplace service, in accordance with an example embodiment.

FIG. 3 is a flowchart depicting a method for facilitating procurement of trade merchandise by one or more purchasing agents for a purchaser, in accordance with another example embodiment.

FIG. 4 is a block diagram depicting a network-based system for use in providing an online procurement marketplace system, according to an example embodiment.

FIG. 5 is a block diagram depicting marketplace application(s) forming part of a network-based procurement marketplace system, according to an example embodiment.

FIG. 6 is a schematic block diagram depicting a mobile device configured for use by a purchaser or a purchasing agent in a procurement transaction facilitated by a network-based procurement service, according to an example embodiment.

FIG. 7 is a diagrammatic representation of a machine in the example form of a computer system within which a set of instructions for causing the machine to perform any one or more of the methodologies discussed herein may be executed.

### DETAILED DESCRIPTION

An example embodiment of the present disclosure describes techniques for facilitating use of other consumers as purchasing agents for a user. The user may, for example, indicate a desire to buy particular merchandise (e.g., a particular product) at a particular price, for example by communicating a purchase offer to a. network-based procurement marketplace service. The purchase offer may be propagated or published to other users of the service, for example being propagated to users that have previously indicated a willingness or desire to act as purchasing agent.

Fulfillment of the purchase offer (also referred to herein as procurement) comprises acquisition of the particular merchandise by the purchasing agent and delivery thereof to the purchaser. Fulfillment may in some instances be consummated by direct delivery to the purchaser, or may in other cases be consummated by delivery to a delivery facility, for example comprising a local facility having multiple lockers or lockboxes.

The facilitating of procurement transactions may include providing functionality for claiming and verifying procurement of merchandise in accordance with respective purchase offers. The facilitating of procurement transactions may further comprise providing intermediated payment functionality, e.g., via an electronic payment service. Such intermediated payment functionality may provide for automated securing of funds from the purchaser for payment to the purchasing agent, and/or may provide for automated payment of the purchasing agent (e.g., from the secured funds) upon verification of delivery of the requested merchandise.

In the following description, for purposes of explanation, numerous specific details are set forth in order to provide a thorough understanding of the various aspects of different embodiments. It will be evident, however, to one skilled in the art, that the present embodiments may be practiced without all of the specific details.

### Example Operating Environment

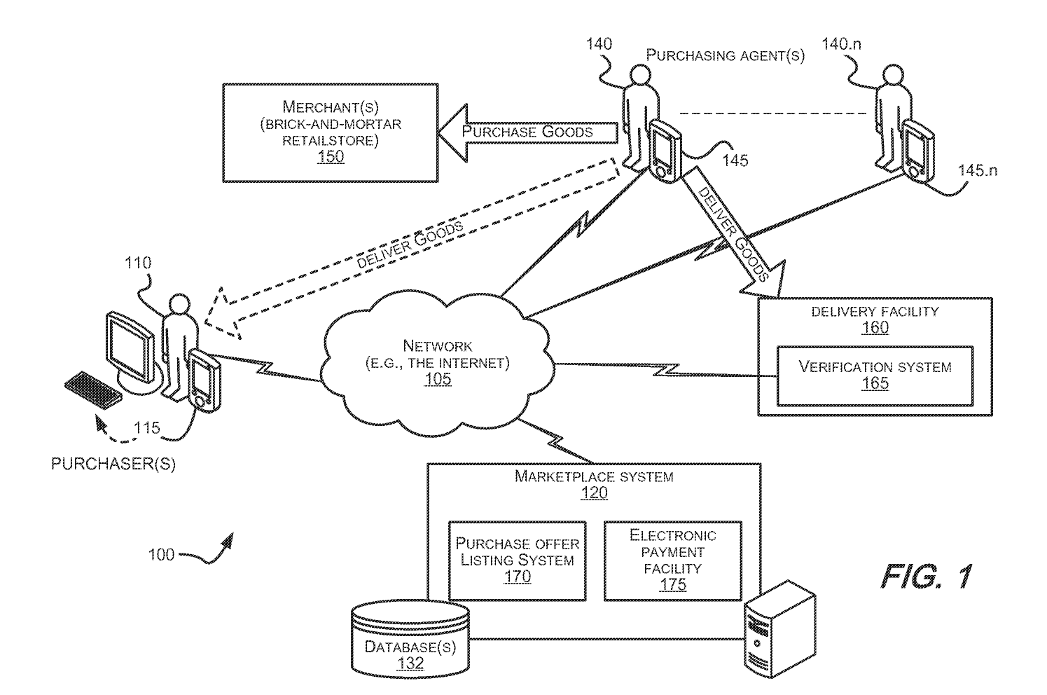

FIG. 1 is a schematic block diagram depicting an example operating environment 100 in which a procurement marketplace service may be provided for facilitating fulfillment of purchase offers from prospective purchasers 110 by purchasing agents 140 (also referred to herein as purchasing agents). According to the example embodiment of FIG. 1, the environment 100 includes a marketplace system 120 in communication with a distributed network 105 (e.g., the Internet) and configured for providing an online or virtual purchase offer marketplace service.

The marketplace system 120 may include a purchase offer listing system 170 configured to enable prospective purchasers 110 to create and publish purchase offers. In this example, purchasers 110 and purchasing agents 140 can connect to the network-based marketplace system 120 via the network 105 by use of respective client computing devices (e.g., desktop, laptop, smart phone, PDA, or similar electronic device capable of some form of data connectivity), further referred to for clarity of description as purchaser devices 115 and purchasing agent devices 145.

in examples where location information of the respective parties are used in facilitating procurement transactions (e.g., for location-based identification of target purchasing agents 140), location information specifying the physical or geographical location of the purchasers 110 and/or the purchasing agent 140 may be communicated to the marketplace system 120. For example, if the device 115, 145 is a mobile device, a GPS unit may inform the device 115, 145 of its location, such that the location information of the device 115, 145 can be shared with the network-based marketplace system 120. Other known techniques for deriving location information may be used with both mobile and non-mobile client computing devices, for example, such as desktop computers, etc. For instance, with some embodiments, the location information indicating the location of the user (i.e., a purchaser 110 or a purchasing agent 140) may be explicitly provided by the user, for example, by interacting with a map interface. The marketplace system 120 include one or more database(s) 132 that stores data used in the provision of the purchase offer marketplace service (e.g., purchase offer data and user data relating to purchasers 110 and purchasing agents 140).

As will be described in greater detail below, each purchase offer specifies particular merchandise which the corresponding purchaser 110 offers to purchase upon delivery thereof by one or more purchasing agents 140, Merchandise which may be the subject of purchase offers can comprise trade goods and/or services. In the further described example embodiments, the merchandise comprises trade goods offered for sale to the public at brick-and-mortar retail stores of a merchant 150. It will be appreciated that the merchandise specified in purchase offers will typically comprise trade goods that are not available for direct online purchase and delivery, e.g., from an online store associated with the merchant 150, or for which delivery is not available directly to the purchaser 110.

Procurement of the specified merchandise, to fulfill the relevant purchase offer, comprises not only acquisition of the merchandise from the third party merchant 150 (i.e., being a third party relative to any agreements or transactions between the purchaser 110 and the purchasing agent 140), but also includes delivery of the acquired merchandise. To this end, a delivery facility 160 may be provided to facilitate secure and verifiable delivery by the purchasing agent 140 for collection by the purchaser 110. The delivery facility 160 may include a verification system 165 to verify delivery of the merchandise. In one example embodiment, the delivery facility 160 comprises multiple separate secure containers for receiving the merchandise, in this example embodiment comprising a series of lockboxes.

The verification system 165 can comprise a system of cameras configured to capture a video record of delivery of merchandise to any of the lockboxes. The video record can afterwards be assessed to verify physical placement by the purchasing agent 140 of the merchandise in a particular lockbox, should a dispute arise as to whether or not the merchandise was indeed delivered. Instead, or in addition, the verification system 165 may include a scanning system configured to scan one or more product codes for the merchandise and/or for scanning one or more codes identifying the relevant purchase offer, purchasing agent device 145, and/or purchaser device 115. The product codes may be visual codes, such as barcodes or quick response (QR) codes, or may comprise a code carried by an electromagnetic signal (e.g., generated by a radiofrequency (RF) tag attached to the merchandise).

In other embodiments, merchandise procured by the purchasing agent 140 may be delivered directly to the purchaser 110, e.g., at a registered address. In such cases, verification of delivery may comprise sending of a delivery verification message from the purchaser device 115 to the marketplace system 120.

To facilitate fulfillment of the purchase offers, each purchase offer may be published, enabling purchasing agents 140 receiving the relevant information to respond to the published purchase offer. In some embodiments, publication of the purchase offers may comprise listing the purchase offers on an online website, so that any purchasing agent 140 accessing the website can view the listed purchase offers. In the present example embodiment, however, publication of the purchase offers may comprise purchase offer notifications sent on the marketplace system 120 directly to user devices associated with the purchasing agents 140 (further referred to as purchasing agent devices 145). In such cases, the marketplace system 120 may maintain a list or set of registered purchasing agents 140 (also referred to herein as a group or set of candidate purchasing agents), with purchase offer notifications sent only to the registered purchasing agents 140, or to a subset of purchasing agents 140. In the current example embodiment, a purchase offer notification is sent only to a subset of purchasing agents 140 (also referred to as target purchasing agents) who satisfy location criteria based on geographic locations of the purchaser 110, the merchant 150, and/or the respective purchasing agent 140.

The marketplace system 120 may further include an electronic payment facility 175 for facilitating payment of the purchasing agents 140 pursuant to fulfillment of purchase offers. The electronic payment facility 175 may provide an electronic payment service (such as, for example, PAYPAL™ or the like) that provides online payment functionalities to users having a registered account with the service. In one example, the electronic payment service has account details providing access to one or more financial accounts for each registered user, for example having the necessary credit card details to effect transfer or funds from a credit card account of each user. In some embodiments, the registration of an account with the electronic payment service provided by the electronic payment facility 175 can be a prerequisite for participation in the procurement marketplace service by any person wishing to participate in the procurement market place server as a purchaser 110 (or, in some cases, as a purchasing agent 140). Although the electronic payment facility 175 is, in this example embodiment, shown in as forming part of the marketplace system 120, and electronic payment service may in other embodiments be provided by an outsourced electronic payment facility, with instructions and/or authorization for funds securement and/or transfer being communicated to the outsourced electronic payment facility from the marketplace system 120.

### Example Method

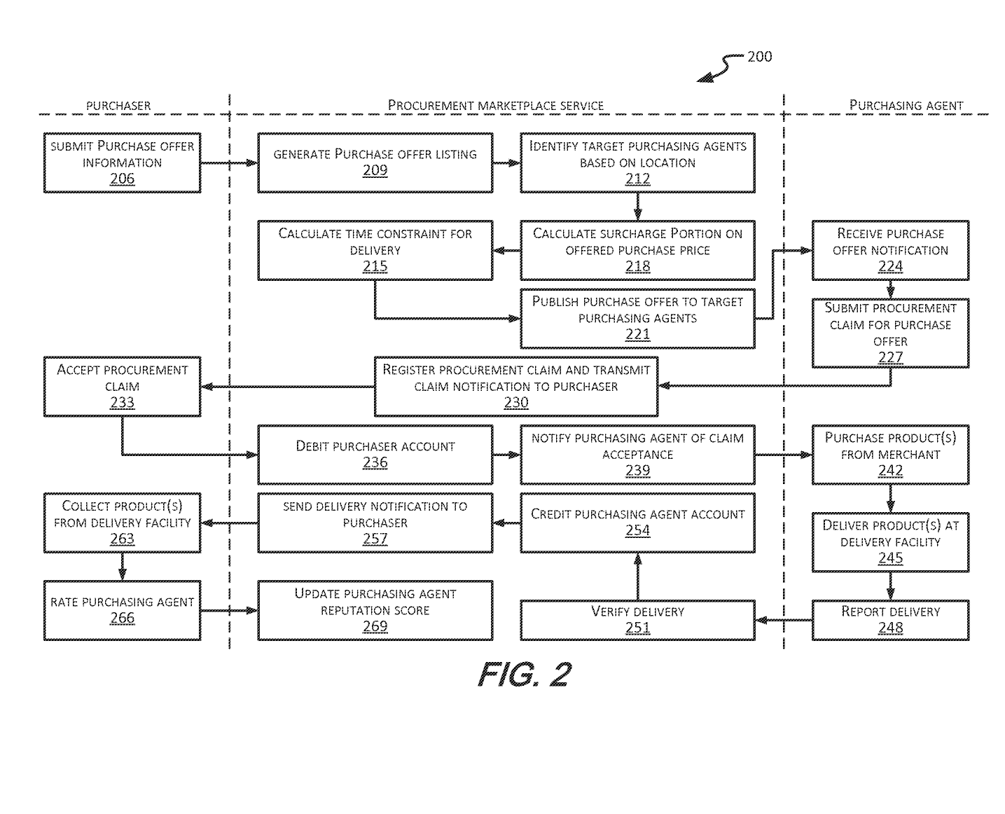

FIG. 2 is a flowchart illustrating a method 200 for providing a network based procurement marketplace service in accordance with an example embodiment, in which the method 200 is performed in the example operating environment 100 of FIG. 1. The method 200 in this example embodiment starts at operation 206 in FIG. 2, with submission by the purchaser 110 (see FIG. 1) of purchase offer information for a particular purchase over whose fulfillment is to be facilitated by the procurement marketplace service provided by the procurement marketplace system 120.

In this example embodiment, the submission of the purchase offer information, at operation 206, comprises the purchaser 110 logging in to a website hosted by the marketplace system 120 via the purchaser device 115. In this example embodiment, the purchaser 110 is an existing, registered user of the procurement marketplace service, with the marketplace system 120 having user account information and user profile information for the purchaser 110. In cases where the purchaser 110 is not an existing registered user, the method 200 may include the prior operations of user registration, which may include provision of user account information by the purchaser 110. The purchaser 110 may then select from a graphical user interface (GUI) presented on the purchaser device 115 a purchase offer listing or creation functionality, and may then be prompted to enter the purchase offer information via a separate GUI provided for entry of purchase offer information in a predefined format. In other embodiments, the submission of purchase offer information, at operation 206, may be performed differently, for example by transmission from the purchaser device 115 of a purchase offer request that includes the purchase offer information (e.g., by means of a telephonic text message transmitted via mobile phone).

In this example embodiment, the purchase offer information comprises specified merchandise to be procured in accordance with the purchase offer, as well as a purchase price which the purchaser 110 offers to pay for procurement of the specified merchandise. The purchase offer information may include a particular specified merchant 150 from which the merchandise is to be purchased. In this example embodiment, the specified merchandise of the purchase offer is a particular computer game which the purchaser 110 knows to be on sate at the GAMESTOP™ chain of stores at a discount price of, say, $40. The purchase price of the purchase offer in this example indicates that the purchaser 110 offers to purchase a delivered copy of the game product for $50. This amount is further referred to as the purchase price.

The purchase offer information may further include location information indicating the geographic location of the purchaser 110 (or, in some instances indicating a particular geographic location at which the purchased product is to be delivered. Such location information may be recently entered by the purchaser 110, for example by indicating the relevant location on a map interface. In other instances, for example where the purchaser 110 communicates with the marketplace system 120 via a purchaser device 115 with geolocation functionality, geographic location information indicating the current geographic location of the purchaser device 115 may automatically be communicated to the marketplace system 120 together with submission of the purchase offer information, at operation 206.

At operation 209, a purchase offer listing is generated by the marketplace system 120 in an automated operation based on the purchase offer information received from the purchaser 110. In some example embodiments, purchase offer listings may be published broadly, so that each purchase offer is accessible without restriction to any visitor of the marketplace website, In other embodiments, purchase offers may be accessible only to individuals who are registered with the procurement marketplace service as purchasing agents 140. In this example embodiment, however, each purchase offer is published only to a selected subset of the registered purchasing agents 140.

The example method 200 includes, at operation 212, identifying from the set of candidate purchasing agents 140 (e.g., comprising all users who have opted in to receiving notifications for opportunities to serve as purchasing agents) a plurality of target purchasing agents 140 based on geographic proximity of the purchasing agents 140 to the purchaser 110 (or to a delivery site associated with the purchase offer, as the case may be). The identification of the target purchasing agents 140 may comprise identifying those candidate purchasing agents 140 whose geographic locations are within a threshold distance (in this case, 10 miles) from the particular purchaser 110 or delivery site. The geographic locations of the purchasing agents 140 may be determined, for the purposes of the identification calculations of operation 212, based, for example, on current geolocation information of the corresponding purchasing agent devices 145, or may be based on location information forming part of respective user profiles or user account information of the purchasing agents 140.

At operation 218, a surcharge on the specified purchase price, and a surcharge portion payable to the purchasing agent 140, is automatically captured. In this example embodiment, the total exposure of the purchaser 110 is not only for the indicated purchase price, but also includes a surcharge limited by the procurement marketplace service for facilitating the procurement transaction between the purchaser 110 and the purchasing agent 140. The total surcharge is, in this case, a fixed percentage of the purchase price, say 10%. The total exposure of the purchaser 110 is thus, in this example, $55. In other embodiments, the surcharge may be a fixed amount.

A portion of the surcharge may in this example embodiment be payable to a purchasing agent 140 who fulfills the purchase offer. Moreover, the particular portion of the surcharge accruing to the purchasing agent 140 may be different for different purchasing agents 140. In this example embodiment, the procurement marketplace service maintains a reputation score for each purchasing agent 140 based on past performance in fulfilling purchase offers, as rated by the relevant purchasers. Calculation of the particular surcharge portion available to the respective identified target purchasing agents 140 may thus be calculated, at operation 218, based at least in part on their respective reputation scores, with a higher reputation score corresponding to a higher portion of the surcharge offered to the purchasing agent. A separate surcharge portion (and therefore a separate advertised proposed procurement price) is thus in this example embodiment calculated, at operation 218, for each one of the target purchasing agents 140. In other embodiments, the total proposed procurement price available to the purchasing agents 140 may be calculated differently. For example, the payment available to the purchasing agents 140 for fulfillment of a purchase offer may be equal to the purchase price offered by the purchaser 110, so that no part of the surcharge accrues to the purchasing agent 140. Instead, the surcharge portion available to the purchasing agents 140 may be a fixed percentage of the surcharge portion, or may be a fixed amount.

The purchase offer may include a time constraint, which indicates a deadline or threshold time period within which procurement of the purchase offer's merchandise is to be completed. Delivery of the merchandise after expiration of the time constraint may in such cases void the purchase offer and result in nonpayment of the purchasing agent 140. In some embodiments, a universal time constraint may apply equally to all the target purchasing agents 140. In this example embodiment, however, the applicable time constraint may be different for different purchasing agents 140. The example method 200 therefore includes, at operation 215, calculating respective time constraints for delivery of the specified product for each of the target purchasing agents 140. Similar to calculation of the applicable surcharge portion, the calculation of the time constraint is in this example embodiment based at least in part on the respective reputation scores of the target purchasing agents 140, with higher reputation scores corresponding to more lenient time constraints. The applicable delivery deadline for a purchasing agent 140 with a relatively low reputation score will thus be earlier in time than the applicable delivery deadline for a purchasing agent 140 with a relatively high reputation score.

At operation 221, the purchase offer is published to the previously identified target purchasing agents 140. In this example embodiment, publication of the purchase offer comprises sending or broadcasting a purchase offer notification to the respective purchasing agent device 145 of each of the target purchasing agents 140. The purchase offer notification may be a text message, for example comprising a short message service (SMS) telephonic text message. As will be evident from the above description, the target purchasing agents 140 in this example embodiment may receive, at operation 224, purchase offer notifications, at least one parameter or attribute of which varies from one notification to the other. In particular, in this example, the notifications for different purchasing agents 140 may indicate different advertised proposed procurement prices (i.e., the value of total payment available to the purchasing agent 140 for fulfillment of the purchase offer, for example comprising the purchaser-provided purchase price plus the respective calculated surcharge portion), and may indicate different time constraints for fulfillment of the purchase offer. In the described example embodiment for procurement of a computer game from a specified merchant 150 for an offered purchase price of $50, the surcharge portion available to the purchasing agent 140 (as calculated at operation 218) is $2. The procurement price offered to the purchasing agent 140 is the sum of these values, i.e., $52. The calculated time constraint applicable to the purchasing agent 140 (as calculated at operation 215) specifies delivery of the purchased computer game within six hours from initial receipt of the purchase offer from the purchaser 110.

Together with these parameters, the purchase offer notification further includes information indicating the merchandise or product(s) to be purchased (in this example embodiment, the particular computer game specified by the purchaser 110), as well as delivery information indicating a delivery site where the purchased product is to be delivered after acquisition thereof by the purchasing agent 140. In this example, the specified delivery site is the delivery facility 160 discussed with reference to FIG. 1. The procurement marketplace service may make use of the multiple delivery facilities 160 that are geographically distributed throughout an area or region in which the procurement marketplace service is provided, The specified delivery site may in such case be the particular delivery facility 160 that is located closest to a geographic location associated with the purchaser 110. In such case, the method 200 may include automatically determining the nearest delivery facility 160 to the purchaser 110's location. Instead, or in addition, the procurement marketplace service may allow for delivery of purchased merchandise by the purchasing agent 140 directly to the purchaser 110, e.g., by delivering at a registered or provided physical address. In such cases, the purchase offer notification may indicate the relevant physical address as the delivery site for the purchase offer.

In summary, the purchase offer notification sent to the purchasing agent 140 therefore, in this example, indicates the merchandise to be procured (i.e., the specified computer game), the merchant 150 from which the product is to be purchased (i.e., GAMESTOP™), the delivery site (i.e., the delivery facility 160 nearest the purchaser 110's location), the offered procurement price (i.e., $52), and the time constraint for fulfillment (say, 6 PM today).

After receipt of the purchase offer notification, a target purchasing agent 140 who wishes to fulfill the purchase offer can, at operation 227, submit a procurement claim to the marketplace system 120 via the purchasing agent device 145. In this example embodiment, submission of the procurement claim indicates a proposal or claim from the purchasing agent 140 to purchase and deliver the specified computer game product under the terms indicated in the purchase offer notification. In different embodiments, the marketplace system 120 may be configured to allow the purchasing agent 140 to specify in the procurement claim an alternative proposed procurement price for which the purchasing agent 140 offers to fulfill the purchase offer. The procurement claim may again be communicated to the marketplace system 120 from the purchasing agent device 145 via any of the above-described mechanisms, in this instance being communicated by an SMS message.

In response to receiving the procurement claim from the purchasing agent 140, the marketplace system 120 can, at operation 230, register receipt of the procurement claim (e.g., including storing in the database(s) 132 event data and claim information associated with receipt of the procurement claim) and transmit to the purchaser device 115 a claim notification reporting the procurement claim by the purchasing agent 140. In this example, the claim notification is again an electronic text message communicated to the purchaser device 115 via the network 105. The claim notification can include that information indicating, for example, a user name and/or reputation score of the corresponding purchasing agent 140. In instances where the procurement claim includes a purchasing-agent provided proposed procurement price, the claim notification may include information indicating the proposed procurement price claim by the corresponding purchasing agent 140.

At operation 233, the purchaser 110 accepts the procurement claim, in this instance by sending an acceptance notification to the marketplace system 120 by use of the purchaser device 115. In this example embodiment, the creation of transactional obligations between the purchaser 110 and the purchasing agent 140 is dependent on purchaser acceptance of the procurement claim (e.g., at operation 233). In other embodiments, however, the process may proceed without requiring purchaser acceptance of the procurement claim. In such cases, for example, the first received procurement claim that satisfies the terms of the purchase offer may automatically be accepted, closing the purchase offer for any other purchasing agents 140.

In the example embodiment of FIG. 2, only a single procurement claim is received, and a single corresponding claim notification is therefore communicated to the purchaser 110, with information regarding the single received procurement claim. In other embodiments, however, multiple procurement bids may be received from different respective purchasing agents 140. In such cases, a separate claim notification may be transmitted to the purchaser device 115 for each received procurement claim. In other embodiments, a single claim notification message may include notification and information about multiple different procurement bids. In either event, the purchaser 110 can then select a preferred procurement claim, and may indicate acceptance of the selected procurement claim by means of the acceptance notification communicated at operation 233. In instances where no proposed procurement price variation is permitted, the purchaser 110 may select the preferred procurement claim based on the reputation scores of the respective purchasing agents 140, time of receipt of the respective procurement bids, and/or identity of the purchasing agents 140, depending on personal preference. In embodiments where purchasing agents 140 are permitted to specify varying proposed procurement prices in their procurement bids, the purchaser 110 may additionally take into account the values of the respectively proposed procurement claims' prices, for example selecting the procurement claim with the lowest proposed procurement price.

Responsive to reception of the acceptance notification, at operation 236, an electronic financial account of the purchaser 110 is automatically debited to provide security for covering payment of the purchasing agent 140 (and, in this example, payment of the procurement marketplace service) pursuant to fulfillment of the procurement transaction by the purchasing agent 140, In some embodiments, securement of funds may comprise placing a hold on funds in the requisite amount in an account of the purchaser 110. In this example embodiment, where the exposure of the purchaser 110 comprises the initially offered purchase price ($50) plus the standard surcharge ($5), the purchaser 110's registered account is automatically debited, at operation 236, in the amount of $55. Securing funds for payment of the purchasing agent 140 in this manner incentivizes and promotes provision of procurement services by the purchasing agents 140, as the purchasing agents 140 can operate confidently in the knowledge that actual fulfillment of the purchase offer will invariably result in prompt payment of the advertised procurement price.

At operation 239, the marketplace system 120 automatically notifies the purchasing agent 140 that the procurement offer was accepted, for example by transmission of an acceptance message from the marketplace system 120 to the purchaser device 115. At operation 242, the purchasing agent 140 then purchases the relevant product from the merchant 130. In this example embodiment, the purchasing agent 140 travels physically to a convenient brick-and-mortar GAMESTOP™ outlet of her choice, from which the requested computer game is then bought by the purchasing agent 140 using her personal funds (e.g., paying the $40 sale price to the merchant 150).

The purchasing agent 140 then travels to ⁻the specified delivery site (here, the delivery facility 160) and physically delivers the purchased product, at operation 245. In this example, delivery entails physically depositing the purchased computer game product in a particular one of the lockboxes provided by the delivery facility 160. In embodiments where the delivery facility 160 includes delivery verification functionality (in this case provided by the verification system 165), delivery of the product at the delivery facility 160 can include capturing delivery information at the delivery facility 160. In this example, a video record of delivery is automatically captured at the delivery facility 160. Additionally, device-driven verification of the purchasing agent 140, purchasing agent device 145, delivered product, and/or the relevant purchase offer may be performed at the delivery facility 160, Such verification may comprise scanning at the delivery facility 160 one or more codes uniquely identifying the purchasing agent device 145, product, and/or purchase offer. For example, the acceptance notification or message sent to the purchasing agent 140 (e.g., at operation 239) may include a unique visual code (e.g., a QR code) associated with the relevant purchase offer. At the delivery facility 160, the visual code can then be displayed on a display screen of the purchasing agent device 145, and the displayed visual code can be scanned by a scanning device forming part of the verification system 165 of the delivery facility 60. Instead, or in addition, a product code carried by the delivered product may be scanned and recorded at the delivery facility 160. Identification information for the particular lockbox (e.g., a lockbox number) can also be recorded automatically or manually at the delivery facility 160.

In this example, the delivery facility 160 is configured such that the lockboxes are closed and locked by default, When the purchasing agent 140 scans the purchase offer QR code at the delivery facility 160, one of the empty lockboxes is automatically opened for receiving the purchased product. The purchasing agent 140 then places the product in the open lockbox. Upon being closed, the lockbox automatically locks and cannot be opened again by the purchasing agent 140. The verification system 165 may automatically record the lockbox number.

At operation 248, delivery of the product is reported to the procurement marketplace service, in this example by means of a delivery report or message transmitted from the purchasing agent device 145 to the marketplace system 120. Instead, or in addition, the delivery report or notification may be communicated directly to the purchaser device 115.

At operation 251, delivery of the product is verified by the marketplace system 120. In this example, delivery verification comprises communication between the marketplace system 120 and the verification system 165 of the delivery facility 160, to confirm delivery information based on the scanned code(s). In some instances, the delivery facility 160 may automatically communicate such verification information to the marketplace system 120 upon receipt of the delivery, in which case verification at the marketplace system 120 can be performed based on the received verification information. The relevant lockbox number is in this case communicated to marketplace system 120 in the delivery notification sent by the purchasing agent 140. Instead, or in addition, the lockbox identification information may be communicated to the marketplace system 120 by the delivery facility 160.

In yet a further embodiment, delivery verification may be performed by a human operator at the delivery facility 160. In such case, the operator may receive the purchased product from the purchasing agent 140, visually inspect the delivered product to verify that it complies with the relevant purchase offer, store the delivered product (e.g., in a separate lockbox) for collection exclusively by the purchaser 110, and thereafter record the verified delivery of the product (which may be automatically communicated to the marketplace system 120).

After delivery is verified, a pre-existing registered financial account of the purchasing agent 140 is automatically credited in the amount of the agreed-upon procurement price. As discussed earlier, the procurement price in this instance comprises the initially offered purchase price ($50) together with the calculated surcharge portion due to the purchasing agent 140 ($2), so that the amount paid into the account of the purchasing agent 140 (at operation 254) in this example embodiment totals $52.

At operation 257, a delivery notification is transmitted to the purchaser device 115, advising the purchaser 110 that the product has been delivered to the specified delivery site. The delivery notification can include collection information to facilitate collection of the product from the delivery facility 160. The collection information in this example includes the relevant lockbox number, together with a unique collection code (here, a visual code in the form of a QR code).

At operation 263, the purchaser 110 collects the delivered product from the delivery facility 160. The purchaser 110 thus travels to the delivery facility 160 and removes the delivered product from the corresponding lockbox. In the current example, this comprises displaying the received collection code on the display screen of the purchaser device 115, and scanning the displayed collection code using a scanning device provided by the delivery facility 160. Upon reading the scanned collection code, the verification system 165 of the delivery facility 160 automatically identifies the corresponding lockbox and automatically causes the lockbox to open, allowing the purchaser 110 to physically remove the delivered product from the lockbox. Video cameras installed at the delivery facility 160 automatically record collection of the product by the purchaser 110, creating and storing a video record of delivery and collection. Such a video record can be accessed in the event of a dispute arising between the purchaser 110 and purchasing agent 140 as to whether or not the product was actually delivered.

In embodiments where a human operator is provided at the delivery facility 160, the collection code may be presented by the purchaser 110 to the operator for scanning. The verification system 165 may in such cases be configured automatically to identify the relevant purchase offer based on scanning of the collection code, thereby verifying to the satisfaction of the operator that the purchaser 110 is authorized to collect the delivered product, and automatically informing the operator of the particular lockbox number associated with the purchase offer. The operator can then retrieve the delivered product from the corresponding lockbox and hand it to the purchaser 110, completing the collection process. In some embodiments, the collection code may comprise a numerical or alphanumerical key code for the lockbox, with the key code and the lockbox number being sent to the purchaser 110 by the procurement marketplace service as part of the delivery notification (e.g., at operation 257). Upon arriving the purchaser 110 may in such a case locate the relevant lockbox based on the received lockbox number, and may open the lockbox by entering the received key code on a keypad of a lock system of the lockbox, to retrieve the delivered product.

In some instances, collection of the product by purchaser 110 completes the method 200. The purchasing agent 140, however, has the option of rating the purchasing agent 140, at operation 266. As is the case with each of the various communications between, on the one hand, the purchaser 110 and the marketplace system 120, and, on the other hand, the purchasing agent 140 and the marketplace system 120, the rating of the purchasing agent 140 may be effected by any one of the various modes of network-based communication between the purchaser device 115 and the marketplace system 120. Here, the purchaser 110 may log in to the website hosted by the procurement market price service, launch a rating interface, and enter rating information via the rating interface. The rating may comprise assigning to the purchasing agent 140 a numerical value on a predefined scale, for example ranging from 1 to 5 stars. in this instance, the rating interface also provides functionality to the purchaser 110 for entering text comments regarding performance of the purchasing agent 140, which comments are accessible for viewing consideration by other prospective purchasers 110. The reputation score of the purchasing agent 140 may then automatically be updated, at operation 269, based on the newly provided rating. The rating system and methodology implemented by the procurement marketplace service may be similar or analogous to rating mechanisms provided by existing online marketplace systems.

### Further Example Method

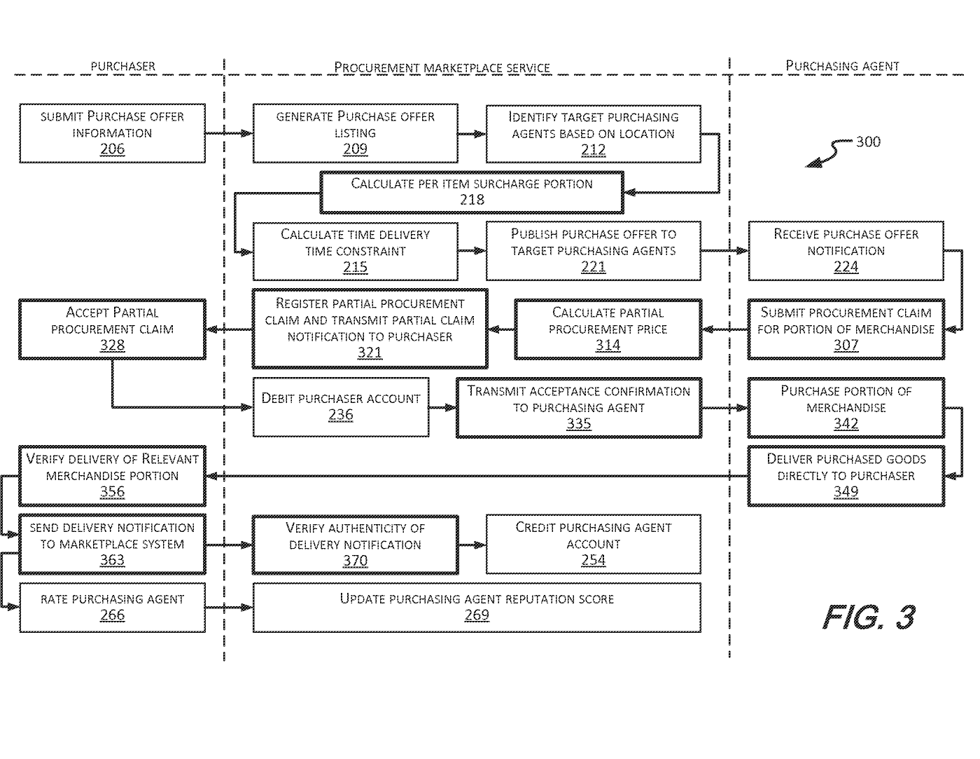

FIG. 3 is a flowchart illustrating a method 300 for a network-based procurement service in accordance with a further example embodiment. The method 300 of FIG. 3 is analogous to the method 200 of FIG. 2, but with a number of variations or distinctions. Operations in common to the methods of FIGS. 2 and 3 are shown in FIG. 3 with relatively thinly lined boxes, while operations unique to the method 300 of FIG. 3 are represented in FIG. 3 with operation boxes having relatively thicker outlines. A number of the variations between the example methods 200 and 300 include that:

(a) the purchase offer merchandise indicated by the purchase offer consists of multiple product items, rather than a single prior item that is to be procured;

(b) a single purchase offer can be fulfilled not only by a single procurement claim from a single purchasing agent 140, but two or more different purchasing agents 140 may submit and fulfill separate procurement claims responsive to a single purchase offer;

(c) the purchase offer does not specify a dictator vendor or merchant from which the requested merchandise is to be purchased, so that purchasing agents 140 can fulfill the purchase offer by procuring the merchandise or trade goods from any merchant;

(d) delivery of purchased goods by each purchasing agent 140 is made directly to the purchaser 110, or to an address associated with the purchaser 110 and/or specified as the delivery site in the purchase offer notification (obviating the use of any delivery facility operated or managed by the procurement marketplace service); and

(e) verification of delivery may be performed at least in part by the purchaser 110, for example by device-driven cooperation between the purchaser 110 and the purchasing agent 140 after inspection of the delivered goods by the purchaser 110.

In the example method 300 of FIG. 3, the purchaser 110 wants to acquire bottles of Pliny the Elder beer, which is in scarce supply. The purchase offer (submitted, e.g., at operation 209) in this case indicates an offered purchase price of $7 per bottle. The purchaser 110 may have the option of specifying a maximum number of the merchandise items (in this case, the maximum number of bottles) that is to be procured. In this case, however, no upper limit to the number of bottles of Pliny the Elder which the purchaser 110 offers to buy is specified. Note that, in this example embodiment, the multiple merchandise items specified in the purchase offer are identical. In other embodiments, however, a single purchase offer may be a bundled purchase offer that requests procurement of two or more different types of merchandise items, with a plurality of items optionally being requested for at least some of the merchandise item types. The purchase offer may, for example, request procurement of a particular printer device, a specified number of compatible printer cartridges, and a specified numbers of reams of papers for each of a plurality of paper sizes.

In one of the variations on the example method 200 of FIG. 2, a purchasing agent 140 may, in the example method 300, submit a procurement claim, at operation 307, for only partial fulfillment of the requested merchandise. In this example embodiment, a particular one of the purchasing agents 140 submits the partial procurement claim, indicating proposed procurement of, say, 6 bottles of Pliny the Elder. Note that the diagram of FIG. 3 represents partial fulfillment by only one of the purchasing agents 140, but that two or more purchasing agents 140 . . . 140.n, each associated with a respective purchasing agent device 145 . . . 145.n (see FIG. 1) can enter into a procurement transaction with the purchaser 110 based on a single, common purchase offer, with each purchasing agent 140 fulfilling apart of the purchase offer.

At operation 314, a partial purchase price and a corresponding surcharge portion is calculated for the partial procurement claim. Note that, at operation 218, the advertised procurement price is calculated on a per item basis, A surcharge portion available to the purchasing agents 140 is thus calculated on a per item basis (say, 40c per bottle, on a total surcharge of, say, $1 per bottle), and the published purchase offer (e.g., at operation 221) indicates an offered procurement price per item (e.g., consisting of the per bottle purchase price offered by the purchaser 110 plus the per bottle surcharge portion available to the purchasing agent 140, equaling $7.40 per bottle in this example). In instances where the purchase offer indicates a specified number of identical merchandise items, the partial procurement price for a. partial procurement claim can be calculated on a pro rata or proportional basis. In cases where the purchase offer indicates two or more different types of merchandise items, partial procurement prices for each partial procurement claim can be calculated based on calculating separate purchase prices and separate surcharge amounts for each merchandise item and/or for each merchandise item type. A combination of proportional and per item price calculation can be employed in appropriate circumstances.

At operation 321, the partial procurement claim is registered at the procurement marketplace system 120, and a corresponding partial claim notification is communicated to the purchaser 110. Operation 321 in this example corresponds to the steps described with reference to operation 230 in FIG. 2, with the exception that they are performed with respect to a procurement claim for only partial fulfillment of the initial purchase offer.

At operation 328, the purchaser 110 responds to the partial claim notification by accepting the indicated partial procurement claim, causing an acceptance notification to be transmitted from the purchaser device 115 to the procurement marketplace system 120. Note, again, that in other embodiments, submission of partial (or complete) procurement claims by purchasing agents 140 and acceptance of the partial procurement claims can instead, or in addition, include direct communications between the purchasing agents 140 and the purchaser 110. In some embodiments, for example, submission of a partial procurement claim (e.g., at operation 307), may comprise an electronic message (e.g., a telephonic text message) transmitted directly from the purchasing agent device 145 to the purchaser device 115. In such a case, acceptance of the partial procurement claim (e.g., at operation 328) may comprise an acceptance notification transmitted only to the procurement marketplace system 120 (from where claim acceptance may be confirmed to the purchasing agent 140), or may comprise notification of partial claim acceptance both to the procurement marketplace service and to the purchasing agent 140.

In this example, the procurement marketplace service secured funds for payment to the purchasing agent 140 in accordance with the partial procurement claim by debiting the purchaser account, at operation 236, an amount of the purchase price for the corresponding number of merchandise items of the partial procurement claim (here, $42 for six bottles of Pliny the Elder at $7 each), together with the full per item surcharge for the indicated number of merchandise items (here, $1 per bottle, resulting in a $48 debiting registered against the purchaser account), At operation 335, acceptance of the partial procurement claim is communicated to the purchasing agent 140 by transmission of an acceptance confirmation to the purchasing agent device 145.

At operation 342, the purchasing agent 140 purchases the indicated portion of the merchandise from a merchant (or other source) of the purchasing agent's choosing, This is in contradistinction to the method 200 of FIG. 2, in which a particular merchant 150 is specified in the purchase offer. In this example, the purchasing agent 140 buys the six bottles of Pliny the Elder from a personal contact.

At operation 349, the purchased trade goods are delivered directly to the purchaser 110, e.g., by dropping off the six bottles of Pliny the Elder at a residential address of the purchaser 110 (indicated, for example, in the purchase offer as the specified delivery site), and/or at a personal meeting with the purchaser 110. In this example embodiment, the purchasing agent 140 travels to the indicated residential address of the purchaser 110, where the purchasing agent 140 is present. The purchased bottles of beer are then received by the purchaser 110, completing delivery.

In this example, verification of delivery, at operation 356, is performed by the purchaser 110 upon receipt of the purchased goods. The purchaser 110 may, for example, verify the number of delivered items, and may sample the contents of a randomly selected one of the bottles, to confirm that it is indeed the requested merchandise. Thereafter, at operation 363, the purchaser 110 sends a delivery notification to the marketplace system 120, to confirm the delivery has occurred. In some instances, the purchasing agent 140 may wish to complete delivery and/or depart from the delivery site only after the delivery notification is sent by the purchasing agent 140. This may be done to ensure that the delivery notification is in fact sent promptly, resulting in prompt crediting of the purchasing agent account (e.g., at operation 254).

In some embodiments, communication of delivery verification to the procurement marketplace service may be device-driven, e.g., being conditional upon performance of a “device handshake” or other near range communication between the purchasing agent device 145 and the purchaser device 115. In one example, the purchasing agent device 145 and the purchaser device 115 may both be mobile devices executing an application provided by the procurement marketplace service, thereby configuring the devices 115 and 145 such that transmission of the delivery notification requires bumping together of the devices, infrared communication by the devices, below-threshold proximity of the devices when a corresponding command is executed, or any other suitable near-range communication mechanism between the devices. As used herein, a handshake between two devices may comprise any one or more of these mechanisms. In some instances, the at least one of the devices 115, 145 may be configured to automatically transmit the delivery notification upon performance of a handshake between the purchasing agent device 145 and the purchaser device 115. Although the delivery notification is shown in FIG. 3 as being sent by the purchaser device 115, a delivery notification may instead, or in addition, be transmitted from the purchaser device 115, conditional on handshake interaction with the particular purchaser device 115 associated with the purchase offer.

In some embodiments, requirement of a device-driven interaction (such as a device handshake) may be dependent on one or more attributes of the relevant purchasing agent 140. In one example, the current reputation score of the particular purchasing agent 140 may dictate whether or not a device handshake is required for delivery verification. Any purchasing agent 140 who has a reputation score below a predefined threshold, for example, can be required to perform a device handshake in order to receive payment of the procurement price, while purchasing agents 140 with reputation scores above the threshold can receive payment without a device handshake. Whether or not a particular purchasing agent 140 is subject to the handshake requirement may be automatically determined by the procurement marketplace system 120 and communicated to the respective purchasing agent 140, e.g., at operation 224.

At operation 370, authenticity of the delivery notification received by the marketplace system 120 may be verified, before crediting the purchasing agent account, at operation 254. Such authenticity verification may comprise automated confirmation that the device from which the delivery notification originates is indeed the particular purchaser device 115 (or purchasing agent device 145, as the case may be) associated with the particular purchaser 110 (or particular purchasing agent 140) in the database(s) 132 of the marketplace system 120.

Note, again, that the illustrated method 300 of FIG. 3 represents partial fulfillment of the purchase offer by a single purchasing agent 140 only. In this embodiment, in which two or more purchasing agents 140 can procure merchandise in fulfillment of a single purchasing offer, operations 307 through 254 and 269 can be repeated (or performed substantially in parallel) for one or more additional purchasing agents 140.x. Each one of the multiple purchasing agents 140 . . . 140.n can thus procure a respective portion of the requested merchandise indicated initially in the purchase offer by the purchaser 110.

### Example System

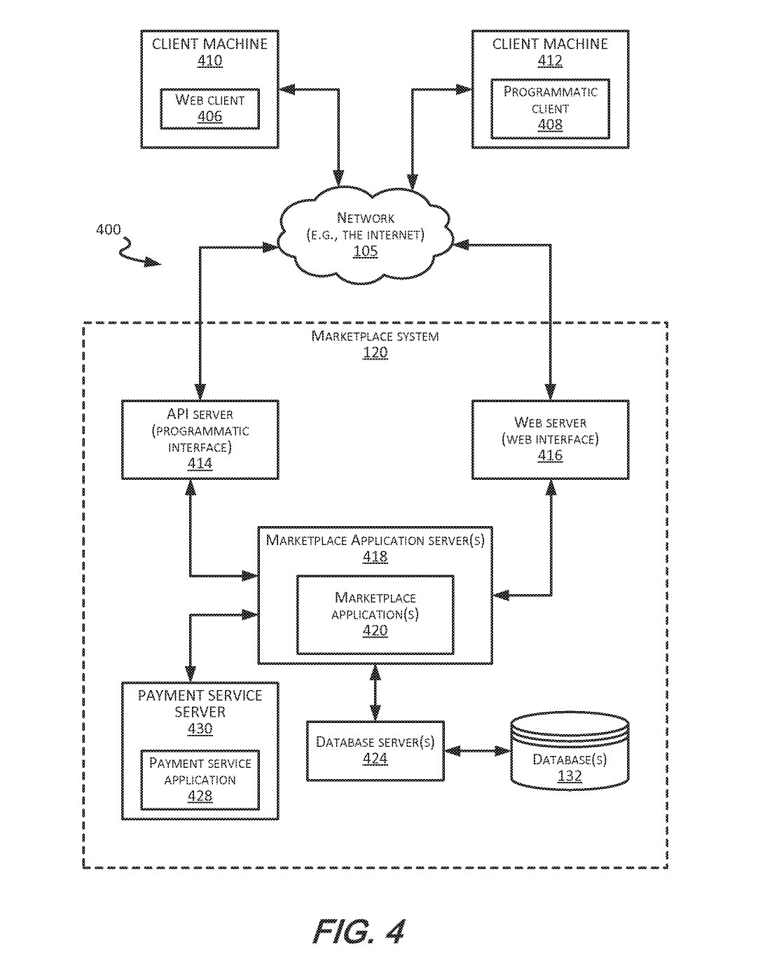

FIG. 4 is a block diagram illustrating a network-based system 400 for providing a network-based procurement marketplace service, as described more fully herein. The block diagram depicts a network-based system 400 (in the exemplary form of a client-server system), within which an example embodiment can be deployed. A networked marketplace system 120 is shown, in the example form of a network-based location-aware system that provides server-side functionality, via a network 105 (e.g., the Internet or WAN) to one or more client machines 410, 412. FIG. 4 illustrates, for example, a web client 406 (e.g., a browser, such as the Internet Explorer browser developed by Microsoft Corporation of Redmond, Washington State) and a programmatic client 408 executing on respective client machines 410 and 412. In an example, the client machines 410 and 412 can each be in the form of a mobile device.

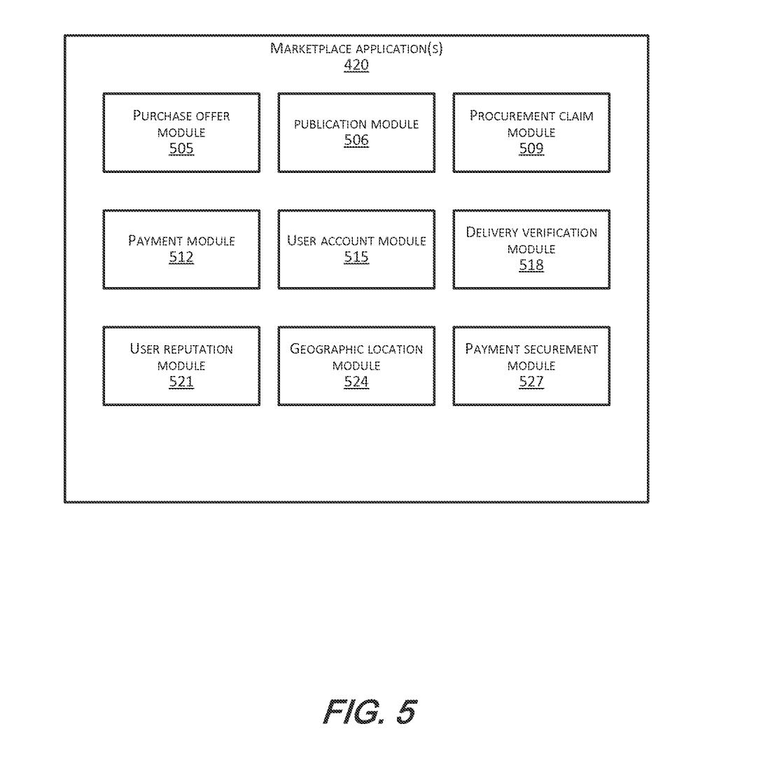

An Application Programming Interface (API) server 414 and a web server 416 are coupled to, and provide programmatic and web interfaces respectively to, one or more application servers 418. The application servers 418 host one or more marketplace application(s) 420 for providing procurement marketplace functionality, as described herein, Example components of the marketplace application(s) 420 are described below with reference to FIG. 5. The application servers 418 are, in turn, shown to be coupled to one or more database servers 424 that facilitate access to one or more databases 132. In some examples, the application server 418 can access the databases 132 directly without the need for a database server 424.

While the various modules and/or components of the marketplace application(s) 420 are described with reference to the example embodiment of FIGS. 4 and 5 to all form part of the networked marketplace system 120, it will be appreciated that, in alternative embodiments, some of the modules may be implemented by services and/or components that are separate and distinct from the networked marketplace system 120. Further, while the system 400 shown in FIG. 4 employs a client-server architecture, the present embodiment is not limited to such an architecture, and could equally well find application in a distributed, or peer-to-peer, architecture system, for example, The various modules on application server 418 could also be implemented as standalone systems or software programs, which do not necessarily have networking capabilities.

The web client 406 accesses the various modules on application server 418 via the web interface supported by the web server 416. Similarly, the programmatic client 408 accesses the various services and functions provided by the modules via the programmatic interface provided by the API server 414. The programmatic client may, for example, be a smartphone application 409. Electronic payment functionality (e.g., to provide at least part of an electronic payment facility 175 as discussed with reference to FIG. 1) may be provided by a payment service server 430 forming part of the marketplace system 120, with payment service application(s) executing on the payment service server 430.

Third party applications, executing on a third party server machine and connected to the network 105 can have programmatic access to the networked marketplace system 120 via the programmatic interface provided by the API server 414. For example, the third party application may, utilizing information retrieved from the networked marketplace system 120, support one or more features or functions on a website hosted by the third party. The third party website may, for example, provide one or more promotional, marketplace or payment functions that are supported by the relevant applications of the networked marketplace system 120.

FIG. 5 is a block diagram illustrating example components of a system for providing a network-based procurement marketplace service in accordance with an example embodiment, in this instance comprising various modules forming part of the marketplace application(s) 420 and the system architecture of FIG. 4. In this example embodiment, the various modules illustrated in FIG. 5 are configured for providing functionality described with reference to corresponding operations in the methods 200 and 300 of FIGS. 2 and 3.

The marketplace application(s) 420 may include a purchase offer module 505 for performing operations associated with receipt of purchase offer information, creation and/or registration of purchase offers. A publication module 506 may be configured to publish the purchase offer, In this example embodiment, the publication module 506 is configured to determine the target purchasing agents 140 (e.g., as previously described), and to communicate the relevant purchase offer information only to the target purchasing agents 140. The publication module 506 may further be configured to calculate agent-dependent purchase offer parameters, and to publish the calculated parameters together with the purchase offer. In one example, different time constraints and/or different procurement prices may be calculated for different target purchasing agents 140 based on differences in their respective reputation scores. As discussed previously, identification of the target purchasing agents 140 may be location-based, with location information in such cases being provided by a geographic location module 524.

A procurement claim module 509 may be configured to receive and verify procurement claims from respective purchasing agents 140, and to notify the purchaser 110 of the procurement claims. The procurement claim module 509 may in addition be configured in some embodiments to receive notification of acceptance of respective procurement claims from the purchaser 110. The securing of funds for payment of each excepted procurement claim (e.g., by debiting or placing a hold on funds in an account of the purchaser 110) may be performed in an automated operation by a payment securement module 527, in this example cooperating with the payment service server 430 (see FIG. 4). Delivery of payment to the respective purchasers 110 following notification and/or verification of delivery may be performed using a payment module 512, in this example again being performed in cooperation with the payment service server 4302. Note that financial functions of the procurement marketplace service (e.g., the securing of funds and the payment of the procurement price) may in some instances be performed wholly by system elements of that form part of the procurement marketplace system 120. In other embodiments, these functionatities may be facilitated by the marketplace system 120, with some operations being effected using a separate electronic payment service, such as PAYPAL™ or the like. In such cases, the payment securement module 527 and the payment module 512 may be configured for communicating to the payment service to authorize operations such as fund securement and payment transfer with respect to respective accounts hosted by the payment service.

Verification of delivery (e.g., in accordance with one or more of the verification methods discussed above with reference to FIGS. 2 and 3) may be performed using a delivery verification module 518. The application(s) 420 may further comprise a user reputation module 521 to provide functionality for managing and updating user reputation scores for the candidate purchasing agents 140. A user account module 515 may further be provided to manage respective user account information and/or profiles for multiple different purchasers 110 and purchasing agents 140.

### Example Mobile Device

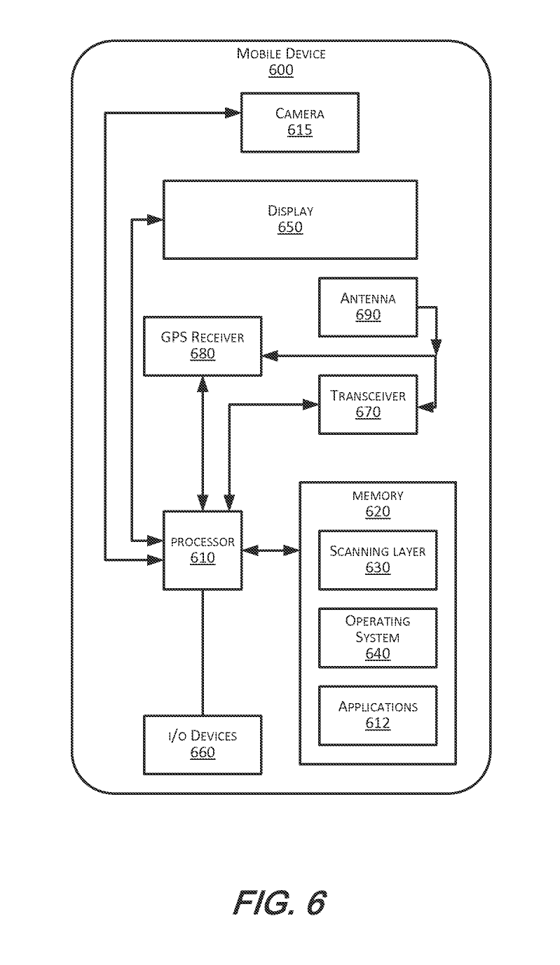

FIG. 6 is a block diagram illustrating a mobile device 600 that may be used as a purchasing agent device 145 or as a purchaser device 115, according to an example embodiment. The mobile device 600 may be any of a variety of types of devices (for example, a cellular telephone, a PDA, a Personal Navigation Device (PND), a handheld computer, a tablet computer, a notebook computer, or other type of movable device). The mobile device 600 may interface via a connection with a communication network, such as the Internet. Depending on the form of the mobile device 600, any of a variety of types of connections and communication networks may be used.

For example, the connection may be Code Division Multiple Access (CDMA) connection, a Global System for Mobile communications (GSM) connection, or other type of cellular connection. Such connection may implement any of a variety of types of data transfer technology, such as Single Carrier Radio Transmission Technology (1xRTT), Evolution-Data Optimized (EVDO) technology, General Packet Radio Service (GPRS) technology, Enhanced. Data rates for GSM Evolution (EDGE) technology, or other data transfer technology (e.g., fourth generation wireless, 4G networks). When such technology is employed, the communication network may include a cellular network that has a plurality of cell sites of overlapping geographic coverage, interconnected by cellular telephone exchanges. These cellular telephone exchanges may be coupled to a network backbone (for example, the public switched telephone networks (PSTN), a packet-switched data network, or other types of networks).

In another example, the connection may be Wireless Fidelity (Wi-Fi, IEEE 802.11x type) connection, a Worldwide Interoperability for Microwave Access (WiMAX) connection, or another type of wireless data connection. In such an embodiment, the communication network may include one or more wireless access points coupled to a local area network (LAN), a wide area network (WAN), the Internet, or other packet-switched data network. In yet another example, the connection may be a wired connection, for example an Ethernet link, and the communication network may be a LAN, a WAN, the Internet, or other packet-switched data network. Accordingly, a variety of different configurations are expressly contemplated.

A plurality of servers may be coupled via interfaces to the communication network, for example, via wired or wireless interfaces. These servers may be configured to provide various types of services to the mobile device 600. For example, one or more servers may execute location based service (LBS) applications, which intemperate with software executing on the mobile device 600, to provide LBSs to a shopper. LBSs can use knowledge of the device's location, and/or the location of other devices and/or retail stores, etc., to provide location-specific information, recommendations, notifications, interactive capabilities, and/or other functionality to a user. With some embodiments, the LBS operates in conjunction with the marketplace system 120, in particular, to provide direction assistance to the user via the mobile device 600, for example to direct the shopper to a delivery site or specified merchant.

The mobile device 600 may include a processor 610. The processor 610 may be any of a variety of different types of commercially available processors suitable for mobile devices (for example, an XScale architecture microprocessor, a Microprocessor without Interlocked Pipeline Stages (MIPS) architecture processor, or another type of processor). A memory 620, such as a Random Access Memory (RAM), a Flash memory, or other type of memory, is typically accessible to the processor 610. The memory 620 may be adapted to store an operating system (OS) 640, as well as application programs 612, a location enabled application that may provide LBSs to a user, and a scanning layer 630 to provide scanning functionality to the mobile device 600. Scanning operations may be performed using, for example, an on-board camera 615 forming part of the device 600. The application programs 612 may include one or modules that are configured to perform the functionalities described above regarding purchase offer generation and submission, procurement claim submission and acceptance, and delivery notification and verification.

The processor 610 may be coupled, either directly or via appropriate intermediary hardware, to a display 650 and to one or more input/output (I/O) devices 660, such as a keypad, a touch panel sensor, a microphone, and the like. Similarly, in some embodiments, the processor 610 may be coupled to a transceiver 670 that interfaces with an antenna 690. The transceiver 670 may be configured to both transmit and receive cellular network signals, wireless data signals, or other types of signals via the antenna 690, depending on the nature of the mobile device 600. In this manner, the connection with the communication network may be established. Further, in some configurations, a GPS receiver 680 may also make use of the antenna 690 to receive GPS signals.

An example geo-location concept is known as a geofence. A geofence can be defined as a perimeter or boundary around a physical location (e.g., a delivery site, purchaser address, or merchant location) or mobile object (e.g., a user). A geofence can be as simple as a radius around a physical location defining a circular region around the location. However, a geofence can be any geometric shape or an arbitrary boundary drawn on a map. A geofence can be used to determine a geographical area of interest for the calculation of demographics, advertising, presenting search results, or similar purposes. For example, a geofence can be used to assist in determining whether a candidate purchasing agent (or mobile device associated with the shopper) is within a geographic area of a particular merchant, a particular purchaser, and/or a particular delivery facility.

### EXAMPLE MACHINE

The various operations of example methods described herein may be performed, at least partially, by one or more processors that are temporarily configured (e.g., by software) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects.

Similarly, the methods described herein may be at least partially processor-implemented. For example, at least some of the operations of a method. may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

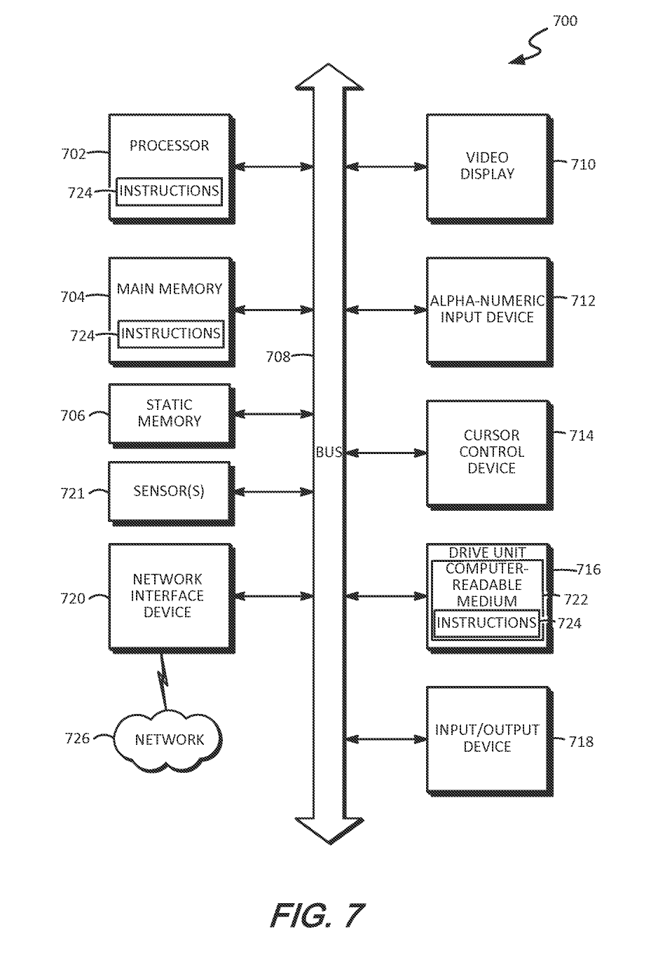

FIG. 7 is a block diagram of a machine in the form of a computer system 700 within which a set of instructions 724 may be executed for causing the machine to perform any one or more of the techniques discussed herein. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a specified embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710, an alphanumeric input device 717 (e.g., a keyboard), and a shopper interface (Up navigation (or cursor control) device 714 (e.g., a mouse). In one embodiment, the display 710, input device 712 and cursor control device 714 are a touch screen display, The computer system 700 may additionally include a machine-readable storage device 716 (e.g., drive unit), an input/output device 718 (e.g., a signal generation device, such as a speaker), network interface device 720, and one or more sensors 721, such as a &bat positioning system sensor, compass, accelerometer, or other sensor.

The drive unit 716 includes a machine-readable medium 722 on which is stored one or more sets of instructions and data structures (e.g., software 723) embodying or utilized by any one or more of the methodologies or functions described herein. The software 723 may also reside, completely or at least partially, within the main memory 704 and/or within the processor 702 during execution thereof by the computer system 700, the main memory 704 and the processor 702 also constituting machine-readable media.

While the machine-readable medium 722 is illustrated in an example embodiment to be a single medium, the term “machine-readable medium” may include a single medium or multiple media (e.g., a centralized or distributed database, and/or associated caches and servers) that store the one or more instructions 724. The term “machine-readable medium” shall also be taken to include any tangible medium that is capable of storing, encoding or carrying instructions (e.g., instructions 724) for execution by the machine and that cause the machine to perform any one or more of the methodologies of the present embodiment, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

### MISCELLANEOUS

It will be seen that the disclosure exemplified by the above-described embodiments include a method of and a system to provide a network-based procurement marketplace system. The system can be configured to perform various operations of the disclosed method. The method may comprise:

receiving a purchase offer from a purchaser (e.g., via a purchase offer module of the system), the purchase offer specifying requested merchandise to be procured for the purchaser, procurement of the requested merchandise including acquisition and delivery of the requested merchandise;

publishing the purchase offer (e.g., by a publication module of the system); receiving (e.g., at a procurement claim module) a procurement claim by a purchasing agent in response to the purchase offer, the procurement claim indicating a proposal by the purchasing agent to procure claimed merchandise comprising at least part of the requested merchandise;

securing funds from an account of the purchaser (e.g., by a funds securement module) for payment to the purchasing agent in accordance with the procurement claim;

receiving a delivery notification (e.g., at a delivery verification module) that indicates delivery of the claimed merchandise by the purchasing agent; and delivering payment to the purchasing agent (e.g., use a payment module) by transferring at least part of the secured funds to an account of the purchasing agent.

Publication of the purchase offer may comprise: determining, for each of a plurality of purchasing agents, a respective agent-dependent parameter that is variable in response to differences in one or more purchasing agent attributes of different purchasing agents; and communicating the purchase offer, including the respective agent-dependent parameter, to each of the plurality of purchasing agents, such that the published agent-dependent parameter, for at least some of the plurality of purchasing agents, is different for different purchasing agents.

In one example embodiment, the one or more purchasing agent attributes includes a reputation score of a corresponding purchasing agent, so that particular terms of the purchase offer published to the purchasing agent may differ corresponding to differences in their respective reputation scores. Instead, or in addition, the one or more purchasing agent attributes may include a geographical location of the purchasing agent, or a location parameter (e.g., geographical proximity) based on location of the purchasing agent relative to the purchaser and/or a delivery site. The agent-dependent parameter may one or more parameters selected from a group comprising: a time constraint within which merchandise delivery is due, and a procurement price payable to the purchasing agent for completing procurement of the requested merchandise. Thus, the purchase offer may be published to specify different time constraints for different purchasing agents, and/or to indicate different procurement prices available to different purchasing agents.

Publication of the purchasing offer may comprise selecting, from a group of candidate purchasing agents, a plurality of target purchasing agents based at least in part on predefined selection criteria, the plurality of target purchasing agents being a subset of the group of candidate purchasing agents. Purchase offer information may in such a case be communicated to only the plurality of target purchasing agents. The predefined selection criteria may comprise a location-based metric that is based at least in part on an agent location representing a geographic location of a respective candidate purchasing agent. In some embodiments, the location-based metric may comprise a geographic proximity between the respective agent location and a delivery site at which merchandise delivery is to occur in accordance with the purchase offer. The predefined selection criteria may provide for identification of a respective candidate purchasing agent as a target purchasing agent conditional upon determining that the corresponding geographic proximity is within a predefined threshold distance.

In such cases, the method thus provides a local purchasing agent service, in that purchase offers are published to only local purchasing agents (being within a threshold distance from the purchaser and/or delivery site), an that only local purchasing agents can respond to any particular purchase offer. A benefit of such location-based publication of purchase offers is that purchasing agents receive notification of only those purchase offers for which they are geographically close enough to fulfill.

The claimed merchandise of a particular procurement claim may comprise only a portion of the requested merchandise. Such procurement claims are also referred to herein as partial procurement claim. The method may in such cases further comprise receiving one or more further procurement claims from one or more further purchasing agents respectively, each further procurement claim being with respect to procurement of a respective portion of the requested merchandise by the associated further purchasing agent. The method may then further comprise, for each of the further purchasing agents that procures a respective portion of the requested merchandise, delivering payment to the further purchasing agent in accordance with the corresponding procurement claim.

The securing of funds from an account of the purchaser may comprise transferring the funds from the purchaser account to an escrow account. In other cases, the securing of funds may comprise placing a hold on funds in the account, fur example by limiting transfers from the account such that a balance of the account remains at all times greater than the relevant amount. The securing funds from the account of the purchaser may be conditional on receiving an acceptance notification that indicates acceptance of the procurement claim by the purchaser. In other instances, funds may be secured automatically upon receipt of the procurement claim.

The method may comprise providing for delivery of the merchandise at a delivery facility having capacity for receiving and separately storing merchandise delivered to the delivery facility in accordance with multiple separate purchase offers. Delivery of the claimed merchandise may be received at the delivery where the delivered merchandise may then be stored for collection by the purchaser. The delivery facility may comprise multiple separate lockable containers, such as a series of numbered lockers or lockboxes. A plurality of separate delivery facilities may be provided at geographically dispersed locations, with each delivery facility serving as a delivery site for a corresponding geographical zone or area in which the procurement service is provided. Multiple contiguous geographical zones or areas (each with its associated delivery facility) may cover a geographical region in which the procurement marketplace service is provided.

The method may further comprise verifying the delivery of the claimed merchandise, the delivering of payment to the purchasing agent being conditional upon the verifying of the delivery, i.e., so that the purchasing agent is eligible to receive the payment if and only if the delivery is verified. In some examples, delivery verification comprises capturing delivery verification data at a delivery facility. In such cases, the capturing of the delivery verification data may include capturing video data of physical delivery of the claimed merchandise to the delivery facility. Instead, or in addition, capturing delivery verification data may include scanning respective product codes of delivered merchandise items, performing device-driven identification of the purchasing agent (e.g., by identifying an associated user device), and/or inspection of the delivered merchandise by a human operator at the delivery facility.

In some instances, delivered may be made directly to the purchaser, or to an address specified by the purchaser. In such cases, delivery verification may be based at least in part on receipt of the delivery notification from a user device associated with the purchaser. In such cases, the delivery notification may indicate that delivery of the claimed merchandise has been verified by the purchaser. In some embodiments, transmission of the delivery notification is conditional upon performance of a near range handshake operation between a user device of the purchaser and a user device of the purchasing agent, receipt of the delivery notification indicating occurrence of the handshake operation between the user devices of the purchaser and the purchasing agent respectively. In this context, “near range” means that a distance between communicating devices corresponds to or is smaller than the distance between individuals who are within touching distance. In one example, the near range handshake operation can be performed only by two devices that are closer than 1 meter apart. In other instances, the handshake operation can only be performed by touching the devices together.

Although specific example embodiments have been described herein, it will be evident that various modifications and changes may be made to these embodiments without departing from the broader spirit and scope of the disclosed subject matter. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. in addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, the disclosed subject matter lies in less than all features of a single disclosed embodiment. Thus, the following claims are hereby incorporated into the Detailed Description, with each claim standing on its own as a separate embodiment.

What is claimed is:

1. A system comprising:
a purchase offer module configured to receive a purchase offer from a purchaser, the purchase offer specifying requested merchandise to be procured for the purchaser, procurement of the requested merchandise including acquisition and delivery of the requested merchandise;
a publication module configured to publish the purchase offer;
a procurement claim module configured to receive a procurement claim by a purchasing agent in response to the purchase offer, the procurement claim indicating a proposal by the purchasing agent to procure claimed merchandise comprising at least part of the requested merchandise;
a payment securement module comprising one or more computer processors configured to secure funds from an account of the purchaser for payment to the purchasing agent in accordance with the procurement claim;
a delivery verification module configured to receive a delivery notification indicating delivery of the claimed merchandise by the purchasing agent; and
a payment module configured to deliver payment to the purchasing agent by transferring at least part of the secured funds to an account of the purchasing agent.

2. The system of claim 1, wherein the publication module is configured to:
determine, for each of a plurality of purchasing agents, a respective agent-dependent parameter that is variable in response to differences in one or more purchasing agent attributes of different purchasing agents; and
communicate the purchase offer, including the respective agent-dependent parameter, to each of the plurality of purchasing agents, such that the published agent-dependent parameter, for at least some of the plurality of purchasing agents, is different for different purchasing agents.

3. The system of claim 2, wherein the one or more purchasing agent attributes includes a reputation score of a corresponding purchasing agent.

4. The system of claim 2, wherein the agent-dependent parameter comprises one or more parameters selected from a group comprising: a time constraint within which merchandise delivery is due, and a procurement price payable to the purchasing agent for completing procurement of the requested merchandise.

5. The system of claim 1, wherein the publication module is further configured to:
select from a group of candidate purchasing agents a plurality of target purchasing agents based at least in part on predefined selection criteria, the plurality of target purchasing agents being a subset of the group of candidate purchasing agents; and
communicate purchase over information to only the plurality of target purchasing agents.

6. The system of claim 5, wherein the predefined selection criteria comprises a location-based metric that is based at least in part on an agent location representing a geographic location of a respective candidate purchasing agent.

7. The system of claim 6, wherein the location-based metric comprises a geographic proximity between the respective agent location and a delivery site at which merchandise delivery is to occur in accordance with the purchase offer.

8. The system of claim 7, wherein the predefined selection criteria provides for identification of a respective candidate purchasing agent as a target purchasing agent conditional upon determining that the corresponding geographic proximity is within a predefined threshold distance.

9. A method comprising:
at a procurement marketplace system, receiving a purchase offer from a purchaser, the purchase offer specifying requested merchandise to be procured for the purchaser, procurement of the requested merchandise including acquisition and delivery of the requested merchandise;
publishing the purchase offer;
at the procurement marketplace system, receiving a procurement claim by a purchasing agent in response to the purchase offer, the procurement c aim indicating a proposal by the purchasing agent to procure claimed merchandise comprising at least part of the requested merchandise;
in an automated operation performed by one or more computer processors, securing funds from an account of the purchaser for payment to the purchasing agent in accordance with the procurement claim;
receiving a delivery notification indicating delivery of the claimed merchandise by the purchasing agent; and
based at least in part on receiving the delivery notification, delivering payment to the purchasing agent by transferring at least part of the secured funds to an account of the purchasing agent.

10. The method of claim 9, wherein the claimed merchandise comprises a portion of the requested merchandise, the method further comprising:
receiving one or more further procurement claims from one or more further purchasing agents respectively, each further procurement claim being with respect to procurement of a respective portion of the requested merchandise by the associated further purchasing agent; and
for each of the further purchasing agents that procures the respective portion of the requested merchandise pursuant to the corresponding further procurement claim, delivering payment to the further purchasing agent in accordance with the corresponding procurement claim.

11. The method of claim 9, wherein the securing funds from t le account of the purchaser is conditional on receiving an acceptance notification that indicates acceptance of the procurement claim by the purchaser.

12. The method of claim 9, further comprising:
providing a delivery facility having capacity for receiving and separately storing merchandise delivered to the delivery facility in accordance with multiple separate purchase offers;
receiving delivery of the claimed merchandise at the delivery facility and securely storing the claimed merchandise at the delivery facility for collection by the purchaser.

13. The method of claim 12, wherein the delivery facility comprises multiple separate lockable containers.

14. The method of claim 12, further comprising providing a plurality of separate delivery facilities at geographically dispersed locations.

15. The method of claim 9, further comprising verifying the delivery of the claimed merchandise, the delivering of payment to the purchasing agent being conditional upon the verifying of the delivery.

16. The method of claim 15, wherein the verifying of the delivery comprises capturing delivery verification data at a delivery facility.

17. The method of claim 16, wherein the capturing of the delivery verification data comprises capturing video data of physical delivery of the claimed merchandise to the delivery facility.

18. The method of claim 15, wherein the verifying of the delivery is based at least in part on receiving the delivery notification, the delivery notification indicating that delivery of the claimed merchandise has been verified by the purchaser.

19. The method of claim 15, wherein transmission of the delivery notification is conditional upon performance of a near range handshake operation between a user device of the purchaser and a user device of the purchasing agent, receipt of the delivery notification indicating occurrence of the handshake operation between the user devices of the purchaser and the purchasing agent respectively.

20. A non-transitory machine-readable storage medium having stored thereon instructions which, in response to execution by a machine, cause the machine to perform operations comprising:
receiving a purchase offer from a purchaser, the purchase offer specifying requested merchandise to be procured for the purchaser, procurement of the requested merchandise including acquisition and delivery of the requested merchandise;
publishing the purchase offer;
receiving a procurement claim by a purchasing agent in response to the purchase offer, the procurement claim indicating a proposal by the purchasing agent to procure claimed merchandise comprising at least part of the requested merchandise;
securing funds from an account of the purchaser for payment to the purchasing agent in accordance with the procurement claim;
receiving a delivery notification indicating deliver of the claimed merchandise by the purchasing agent; and
based at least in part on receiving the delivery notification, delivering payment to the purchasing agent by transferring at least part of the secured funds to an account of the purchasing agent.
